(19) United States
(12) Patent Application Publication
(10) Pub. No.: US 2023/0009538 A1
(43) Pub. Date: Jan. 12, 2023

(54) APPLICATION METHOD AND APPLICATOR DEVICE

(71) Applicant: HONDA MOTOR CO., LTD., Tokyo (JP)

(72) Inventors: Yutaro UENO, Tokyo (JP); Shunsuke KIMURA, Tokyo (JP); Takashi YAMAMURO, Tokyo (JP); Hironobu HAYAMA, Tokyo (JP); Hirofumi MIMA, Tokyo (JP); Shinya MURAKAMI, Tokyo (JP)

(21) Appl. No.: 17/810,836

(22) Filed: Jul. 6, 2022

(30) Foreign Application Priority Data
Jul. 8, 2021 (JP) 2021-113245

(51) Int. Cl. B05B 12/10; B05D 1/02; B05B 12/00; B05B 1/32

(52) U.S. Cl. CPC B05B 12/10; B05D 1/02; B05B 12/004; B05B 1/32

(57) ABSTRACT

Provided is an application method including: a feeding step including feeding a viscous material to a discharge member; a temperature measurement step including measuring a temperature of the viscous material in a flow path through which the viscous material is fed to the discharge member; a pressurizing step including pressurizing the viscous material fed to the discharge member, based on the temperature measured in the temperature measurement step; and a discharge step including discharging, through the discharge member, the viscous material pressurized in the pressurizing step.

This application is based on and claims the benefit of priority from Japanese Patent Application 2021-113245, filed on 8 Jul. 2021, the content of which is incorporated herein by reference.

### BACKGROUND OF THE INVENTION

### Field of the Invention

The present invention relates to an application method and an applicator device.

### Related Art

Conventionally, application methods for applying a liquid to a target have been known. Such a method uses, for example, a robot equipped with a spray gun, and the liquid is sprayed through a discharge port of the spray gun while the spray gun is being moved.

Patent Document 1 discloses a method according to which, in a state where a path from a liquid reservoir to a discharge port is filled with a liquid, the liquid is pressurized prior to start of discharge of the liquid such that the liquid is discharged at a constant flow rate.
Patent Document 1: Japanese Patent No. 3590300

### SUMMARY OF THE INVENTION

However, in a case where a viscous material is used as the liquid, the viscous material is likely to be affected by the environment of the path from the liquid reservoir to the discharge port because the viscosity of the viscous material varies significantly due to changes in temperature. For this reason, as shown in FIG. 1, there is a disadvantage that a decrease in the temperature of the viscous material causes narrowing T in the vicinity of the starting point S of an application line, whereas an increase in the temperature of the viscous material causes widening in the vicinity of the starting point S of the application line.

An object of the present invention is to provide an application method and an applicator device that are capable of preventing or reducing occurrence of the narrowing and widening in the vicinity of a starting point of an application line even in a case where a viscous material is discharged.

An aspect of the present invention is directed to an application method including: a feeding step including feeding a viscous material to a discharge member; a temperature measurement step including measuring a temperature of the viscous material in a flow path through which the viscous material is fed to the discharge member; a pressurizing step including pressurizing the viscous material fed to the discharge member, based on the temperature measured in the temperature measurement step; and a discharge step including discharging, through the discharge member, the viscous material pressurized in the pressurizing step.

According to the application method described above, the feeding step, the temperature measurement step, the pressurizing step, and the discharge step may be repeated two or more times.

According to the application method described above, the discharge step may be repeated two or more times such that the viscous material is discharged at different discharge flow rates, and the viscous material fed to the discharge member is pressurized based on the temperature measured in the temperature measurement step and one of the different discharge flow rates for discharging the viscous material.

Another aspect of the present invention is directed to an applicator device including: a discharge member; a reservoir that stores a viscous material; a flow path through which the reservoir and the discharge member communicate with each other; a feeder that feeds the viscous material stored in the reservoir to the discharge member and pressurizes the viscous material fed to the discharge member; a temperature meter that measures a temperature of the viscous material in the flow path; and a controller that controls a pressure to be applied to pressurize the viscous material fed to the discharge member, based on the temperature measured by the temperature meter. The discharge member is configured to discharge the viscous material pressurized by the feeder.

The discharge member may include a discharge port and an on-off valve that opens and closes the discharge port. The discharge member may pressurize the viscous material fed to the discharge member in a state where the on-off valve is closed, and may discharge the pressurized viscous material through the discharge port in a state where the on-off valve is open.

The controller may control the pressure to be applied to pressurize the viscous material fed to the discharge member, based on the temperature measured by the temperature meter and a discharge flow rate for discharging the viscous material.

The present invention provides the application method and the applicator device that are capable of preventing or reducing occurrence of narrowing and widening in the vicinity of a starting point of an application line even in a case where a viscous material is discharged.

### BRIEF DESCRIPTION OF THE DRAWINGS

FIG. 1 is a diagram illustrating narrowing that occurs in the vicinity of the starting point of an application line formed by discharging a viscous material;

FIG. 2 is a table showing a relationship between a temperature of a viscous material in a flow path and a temperature correct ion factor;

FIG. 3 is a diagram illustrating an example of an applicator device according to an embodiment;

FIG. 4 is a diagram illustrating a structure of the spray gun in FIG. 3;

FIG. 5 shows results of measurement of the width of a portion with narrowing or widening in the vicinity of the starting point of application lines formed by applying a viscous material by an application method of Example 1 and an application method of Comparative Example 1; and

FIG. 6 shows results of measurement of the width of a portion with narrowing or widening in the vicinity of the starting point of application lines formed by repeatedly applying a viscous material ten times by the application method of Example 1.

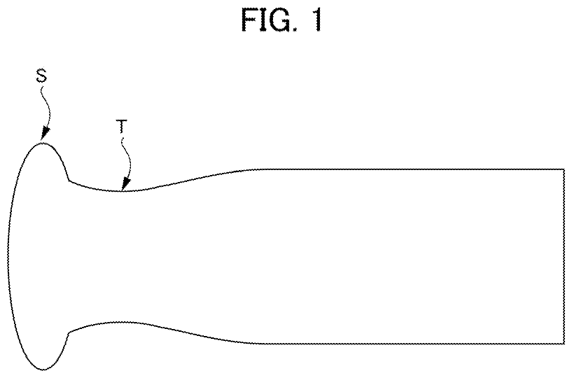

### DETAILED DESCRIPTION OF THE INVENTION

Embodiments of the present, invention will be described with reference to the drawings.

### Application Method

An application method according to the present embodiment includes: a feeding step including feeding a viscous material to a discharge member; a temperature measurement step including measuring a temperature of the viscous material in a flow path through which the viscous material is fed to the discharge member; a pressurizing step including pressurizing the viscous material fed to the discharge member, based on the temperature measured in the temperature measurement step; and a discharge step including discharging, through the discharge member, the viscous material pressurized in the pressurizing step. According to this method, even if the viscosity of the viscous material in the flow path varies due to a change in the temperature of the viscous material affected by the environment, the feature in which the viscous material fed to the discharge member is pressurized based on the temperature measured in the temperature measurement step makes it possible to reduce or prevent the occurrence of the narrowing and widening in the vicinity of the starting point of an application line. In contrast in a case where the viscous material fed to the discharge member is not pressurized based on the temperature measured in the temperature measurement step, the narrowing or widening occurs in the vicinity of the starting point of an application line.

The viscous material has such a viscosity that allows narrowing or widening to occur in the vicinity of the starting point of an application line in the case where the viscous material fed to the discharge member is not pressurized based on the temperature measured in the temperature measurement step. For example, the viscosity at 27° C. is 70 Pa·s or higher.

The viscous material is not particularly limited, and examples thereof include an adhesive, a sealant, etc.

The discharge member is not particularly limited as long as it is capable of discharging the viscous material, and examples of the discharge member include a spray gun, a discharge head, etc.

The flow path is not particularly limited, and examples thereof include a hose, a pipe, etc.

A known temperature sensor can be used to measure a temperature of the viscous material in the flow path.

The temperature of the viscous material in the flow path may be measured at any timing. For example, the temperature may be measured at a timing when an amount of the viscous material fed for a first application reaches a predetermined value, and/or a timing immediately before the start of the second and subsequent applications.

An average of temperatures measured during a predetermined period may be defined as the measured temperature of the viscous material in the flow path,

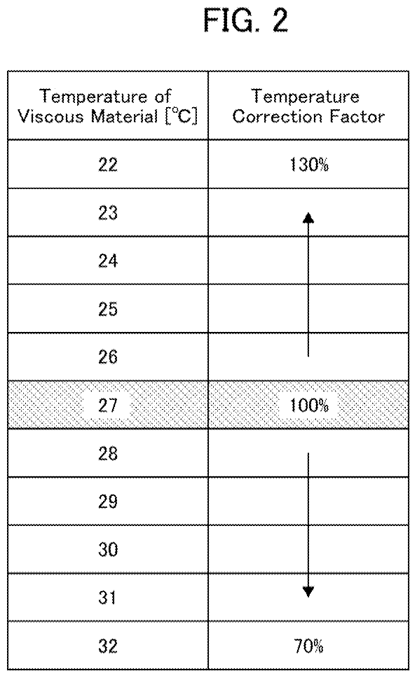

A pressure to be applied to pressurize the viscous material fed to the discharge member based on the temperature measured in the temperature measurement step is determined by, for example, multiplying a pressure to be applied to the viscous material at a predetermined reference temperature (e.g., 27° C.) by a temperature correction factor (see FIG. 2). Here, since the viscosity of the viscous material increases as the temperature of the viscous material decreases, the temperature correction factor needs to be increased when the temperature of the viscous material decreases. Since the viscosity of the viscous material decreases as the temperature of the viscous material increases, the temperature correction factor needs to be decreased when the temperature of the viscous material increases.

The viscous material fed to the discharge member may be pressurised by any method, examples of which include feeding the viscous material to the flow path using a known pump, pressurising the viscous material in the flow path using a pressuring member, and the like.

The pressure of the viscous material fed to the discharge member may be controlled according to, for example, a condition under which the viscous material is fed to the flow path using a known pump or a condition under which the viscous material is pressurized using a pressuring member, or by way of measurement of the pressure of the viscous material in the flow path using a known pressure sensor,

The viscous material fed to the discharge member may be pressurized such that a discharge flow rate at which the viscous material pressurized in the pressurizing step is discharged through the discharge member is maintained,

According to the application method of the present embodiment the feeding step, the temperature measurement step, the pressurizing step, and the discharge step may be repeated two or more times.

In a case where the discharge step is performed repeatedly such that the viscous material is discharged at different discharge flow rates, the viscous material fed to the discharge member may be pressurized based on the temperature measured in the temperature measurement step and one of the different discharge flow rates for discharging the viscous material. Here, an increase in the pressure to be applied to the viscous material fed to the discharge member increases the discharge flow rate for discharging the viscous material. A decrease in the pressure to be applied to the viscous material fed to the discharge member reduces the discharge flow rate for discharging the viscous material.

### [Applicator Device]

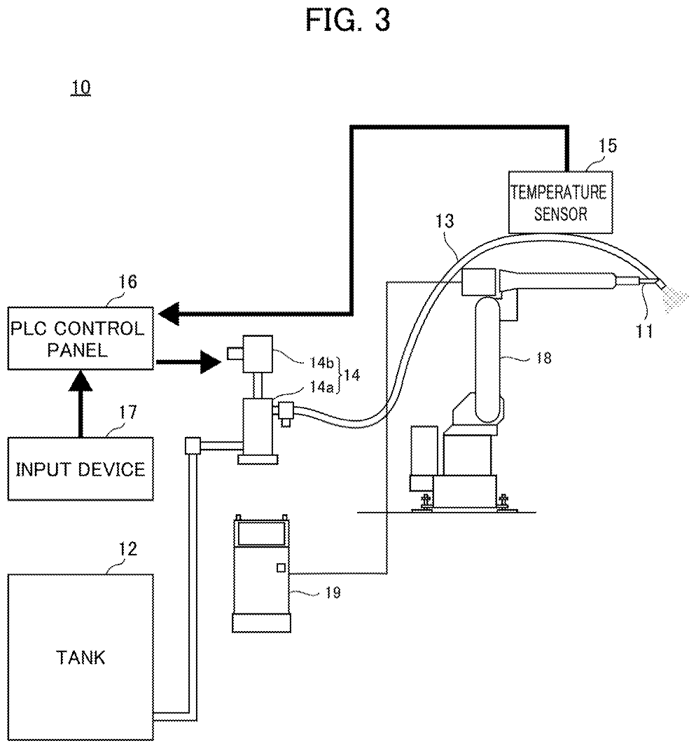

FIG. 3 illustrates an applicator robot 10 as an example of the applicator device according to the present embodiment.

The applicator robot 10 includes: a spray gun 11 as a discharge member; a tank 12 as a reservoir that stores a viscous material; a hose 13 as a flow path through which the spray gun 11 and the tank 12 communicate with each other; and a pump 14 as a feeder that feeds the viscous material from the tank 12 to the spray gun 11 and pressurizes the viscous material fed to the spray gun 11. The pump 14 includes a cylinder 14a and a motor 14b for driving the cylinder 14a. The applicator robot 10 further includes a temperature sensor 15 as a temperature meter that measures the temperature of the viscous material in the hose 13, and a PLC control panel 16 as a controller that controls the pressure to be applied to pressurize the viscous material fed to the spray gun 11 based on the temperature measured by the temperature sensor 15. The spray gun 11 discharges the viscous material that has been pressurized by the pump 14.

The PLC control panel 16 controls the pressure to be applied to pressurize the viscous material fed to the spray gun 11 by using, for example, the aforementioned temperature correction factor (see FIG. 2), according to a condition under which the viscous material is fed to the hose 13.

To change the discharge flow rate for discharging the viscous material, the PLC control panel 16 controls the pressure to be applied to pressurize the viscous material fed to the spray gun 11, based on the temperature measured by the temperature sensor 15 and the discharge flow rate for discharging the viscous material.

The PLC control panel 16 is connected to an input device 17, and the pressure to be applied to the viscous material fed to the spray gun 11 based on the temperature measured by the temperature sensor 15 may be inputted via the input device 17.

The applicator robot 10 may further include a pressure sensor for measuring the pressure of the viscous material in the hose 13. In this case, the pressure of the viscous material fed to the spray gun 11 can be controlled by way of measurement of the pressure of the viscous material in the hose 13 by the pressure sensor.

The input device 17 is not particularly limited, and examples thereof include a PC, a GOT, etc.

The spray gun 11 is mounted on a robot, body 18, and the motion of the robot body 28 is controlled by a robot controller 19.

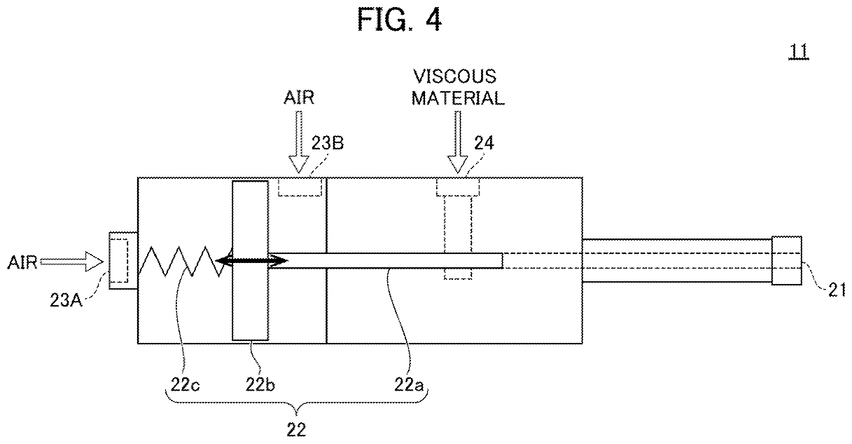

FIG. 4 illustrates the structure of the spray gun 11.

The spray gun 11 includes a discharge port 21 and a needle valve 22 as an on-off valve for opening and closing the discharge port 21. Here, the needle valve 22 includes a needle 22a, a piston 22b that holds the needle 22a movably in an axial direction of the spray gun 11, and a spring 22c that elastically supports the piston 22b. The spray gun 11 has air supply ports 23A and 23B, and a viscous material feeding port 24 that is connected to the hose 13. Air supplied through the air supply port 23A moves the piston 22b to the right in the axial direction, whereby the viscous material fed through the viscous material feeding port 24 to the spray gun 11 is pressurized in a state where the needle valve 22 is closed. On the other hand, air supplied through the air supply port 23B moves the piston 22b to the left in the axial direction, whereby the pressurized viscous material is discharged through the discharge port in a state where the needle valve 22 is open.

While an embodiment of the present invention has been described in the foregoing, the present invention is not limited to the embodiment described above, and appropriate modifications may be made to the embodiment described above without deviating from the spirit of the present invention.

### EXAMPLES

Examples of the present invention will be described below. It should be noted that the present invention is not limited to the following examples.

### Example 1

Using the applicator robot 10 (see FIG. 3), a sealant having a viscosity of 77 Pa·s at 27° C. was applied to a steel plate in the form of a 120 mm wide line. The viscous material was applied at liquid temperatures of 22° C., 21° C., and 32° C. The viscous material fed to the spray gun 11 was pressurized based on the temperature measured by the temperature sensor 15 and the temperature correction factor (see FIG. 2).

### Comparative Example 1

The viscous material was applied in the same manner as in Example 1, except that the viscous material fed to the spray gun 11 was pressurized based on the temperature correction factor at 27° C. (see FIG. 2) but without using the temperature sensor 15.

[Width of Portion with Narrowing or Widening in Vicinity of Starting Point of Application Line]

The width of a portion with narrowing (minimum value) or the width of a portion with widening (maximum value) in the vicinity of the starting point of the application line was measured.

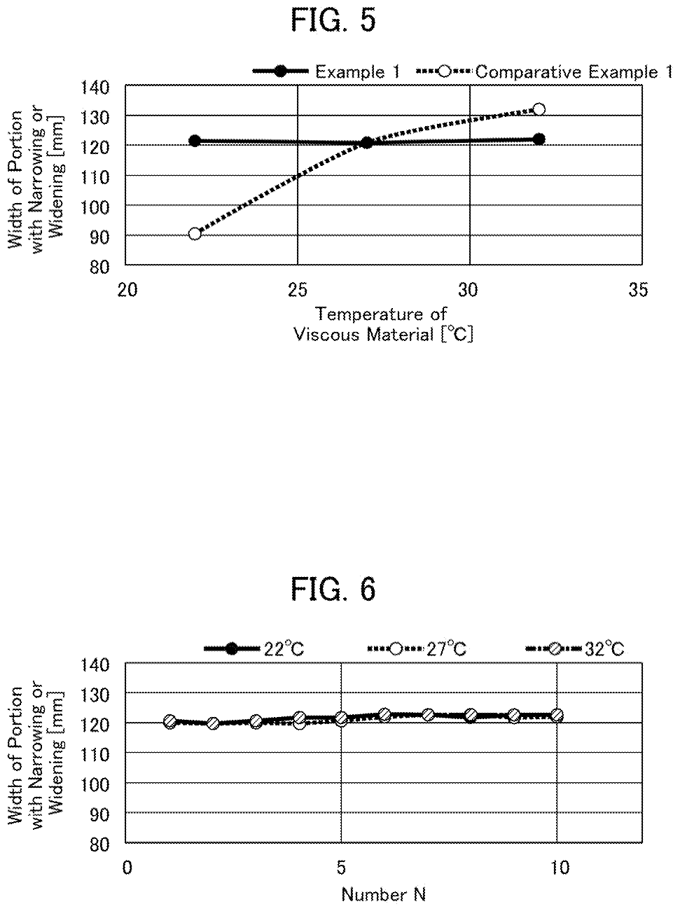

FIG. 5 shows the results of the measurement of the width of the portion with narrowing or the width of the portion with widening in the vicinity of the starting point of the application line.

FIG. 5 indicates that the application method of Example 1 prevents or reduces the occurrence of the narrowing and widening in the vicinity of the starting point of the application line. In this example, the width of the portion with narrowing or the width of the portion with widening in the vicinity of the starting point of the application line was within a range of 0.5% with respect to the set value (120 mm).

In contrast, the application method of Comparative Example 1 allowed narrowing to occur in the vicinity of the starting point of the application line when the temperature of the viscous material was 22° C., and allowed widening to occur in the vicinity of the starting point of the application line when the temperature of the viscous material was 32° C.

Next, by using the application method of Example 1, the viscous material at a liquid temperature of 22° C., the viscous material at a liquid temperature of 27° C., and the viscous material at a liquid temperature of 32° C. were each applied repeatedly ten times.

FIG. 6 shows the measurement results of the width of a portion with narrowing or the width of a portion with widening in the vicinity of the starting point of the application line.

FIG. 6 indicates that even if the viscous material is repeatedly applied ten times the application method of Example 1 reduces the occurrence of narrowing and widening in the vicinity of the starting point of the application line.

### EXPLANATION OF REFERENCE NUMERALS

10: Applicator robot
11: Spray gun
12: Tank
13: Hose
14: Pump
14a: Cylinder
14b: Motor
15: Temperature sensor
16: PLC control panel
17: Input device
18: Robot body
19: Robot controller
21: Discharge port
22: Needle valve
2a: Needle
22b: Piston
22c: Spring
23A, 23B: Air supply port
24: Viscous material feeding port

What is claimed is:

1. An application method comprising:
a feeding step including feeding a viscous material to a discharge member;
a temperature measurement step including measuring a temperature of the viscous material in a flow path through which the viscous material is fed to the discharge member;
a pressurizing step including pressurizing the viscous material fed to the discharge member, based on the temperature measured in the temperature measurement step; and
a discharge step including discharging, through the discharge member, the viscous material pressurized in the pressurizing step.

2. The application method according to claim 1,
wherein the feeding step, the temperature measurement step, the pressurizing step, and the discharge step are repeated two or more times.

3. The application method according to claim 2,
wherein the discharge step is repeated two or more times such that the viscous material is discharged at different discharge flow rates, and
wherein the viscous material fed to the discharge member is pressurized based on the temperature measured in the temperature measurement step and one of the different discharge flow rates for discharging the viscous material.

4. An applicator device comprising:
a discharge member;
a reservoir that stores a viscous material;
a flow path through which the reservoir and the discharge member communicate with each other;
a feeder that feeds the viscous material stored in the reservoir to the discharge member and pressurizes the viscous material fed to the discharge member;
a temperature meter that measures a temperature of the viscous material in the flow path; and
a controller that controls a pressure to be applied to pressurize the viscous material fed to the discharge member, based on the temperature measured by the temperature meter,
the discharge member being configured to discharge the viscous material pressurized by the feeder.

5. The applicator device according to claim 4,
wherein the discharge member comprises a discharge port and an on-off valve that opens and closes the discharge port,
wherein the discharge member pressurises the viscous material fed to the discharge member in a state where the on-off valve is closed, and
wherein the discharge member discharges the pressurized viscous material through the discharge port in a state where the on-off valve is open.

6. The applicator device according to claim 4,
wherein the controller controls the pressure to be applied to pressurize the viscous material fed to the discharge member, based on the temperature measured by the temperature meter and a discharge flow rate for discharging the viscous material.
